(19) United States
(12) Patent Application Publication
(10) Pub. No.: US 2023/0265591 A1
(43) Pub. Date: Aug. 24, 2023

(54) METHOD OF USING IMAGE RECOGNITION PROCESSES TO PREVENT COLOR CONTAMINATION ISSUES IN A LAUNDRY APPLIANCE

(71) Applicant: Haier US Appliance Solutions, Inc., Wilmington, DE (US)

(72) Inventors: Hyeonsoo Moon, Seoul (KR); Hoyoung Lee, Seoul (KR); Khalid Jamal Mashal, Louisville, KY (US); Jeonghoon Lee, Seoul (KR); Je Kwon Yoon, Gyeonggi (KR)

(21) Appl. No.: 17/679,193

(22) Filed: Feb. 24, 2022

(51) Int. Cl. D06F 34/18; D06F 33/32; D06F 34/05; D06F 34/28; G06V 10/56; G06V 10/82

(52) U.S. Cl. CPC D06F 34/18; D06F 33/32; D06F 34/05; D06F 34/28; G06V 10/56; G06V 10/82; D06F 2105/58

(57) ABSTRACT

A washing machine appliance includes a wash basket that is rotatably mounted within a wash tub and that defines a wash chamber for receiving a load of clothes. A motor assembly is mechanically coupled to the wash basket for selectively rotating the wash basket and a camera assembly is mounted within the cabinet in view of the wash chamber. A controller is configured to obtain a first image of the load of clothes using the camera assembly, operate the motor assembly to tumble the load of clothes, obtain a second image of the load of clothes using the camera assembly, analyze the first image and the second image using an image recognition process to identify one or more outlier garments, and implement a responsive action in response to identifying the one or more outlier garments.

### FIELD OF THE INVENTION

The present subject matter relates generally to washing machine appliances, or more specifically, to methods for using image recognition processes to identify and correct color contamination issues in a washing machine appliance.

### BACKGROUND OF THE INVENTION

Washing machine appliances generally include a cabinet which receives a wash tub for containing water or wash fluid (e.g., water and detergent, bleach, or other wash additives). The wash tub may be suspended within the cabinet by a suspension system to allow some movement relative to the cabinet during operation. A wash basket is rotatably mounted within the wash tub and defines a wash chamber for receipt of articles for washing. A drive assembly is coupled to the wash tub and is configured to selectively rotate the wash basket within the wash tub.

Prior to an operating cycle, a user typically places a load of laundry in the wash chamber, selects cycle parameters, and initiates the wash cycle. However, if a user loads the wash chamber with clothes having different colors, it is possible that initiating the wash cycle may result in colors bleeding among the clothes. For example, if a user provides a load that is primarily bright whites but includes a dark item as well, e.g., such as jeans or a dark sweater, the load of bright whites may be contaminated with dye or color that bleeds from the dark item. Notably, conventional washing machine appliances do not have methods for detecting load conditions that may result in color contamination. Moreover, a visual inspection of the load may not always reveal a dark item in a light load. For example, in a top load washer, the dark item may be buried underneath the white clothes and may not be visible from the top of the wash tub.

Accordingly, a washing machine appliance with improved systems and methods for preventing color contamination within loads is desirable. More specifically, a method for automatically detecting situations where color bleed may occur and implementing correction action would be particularly beneficial.

### BRIEF DESCRIPTION OF THE INVENTION

Advantages of the invention will be set forth in part in the following description, or may be apparent from the description, or may be learned through practice of the invention.

In one exemplary embodiment, a washing machine appliance is provided including a wash tub positioned within a cabinet, a wash basket rotatably mounted within the wash tub and defining a wash chamber configured for receiving a load of clothes, a motor assembly mechanically coupled to the wash basket for selectively rotating the wash basket, a camera assembly mounted within the cabinet in view of the wash chamber, and a controller operably coupled to the motor assembly and the camera assembly. The controller is configured to obtain a first image of the load of clothes using the camera assembly, operate the motor assembly to tumble the load of clothes, obtain a second image of the load of clothes using the camera assembly, analyze the first image and the second image using an image recognition process to identify one or more outlier garments, and implement a responsive action in response to identifying the one or more outlier garments.

In another exemplary embodiment, a method of operating a washing machine appliance is provided. The washing machine appliance includes a wash basket rotatably mounted within a wash tub and defining a wash chamber configured for receiving a load of clothes, a motor assembly for selectively rotating the wash basket, and a camera assembly mounted within the cabinet in view of the wash chamber. The method includes obtaining a first image of the load of clothes using the camera assembly, operating the motor assembly to tumble the load of clothes, obtaining a second image of the load of clothes using the camera assembly, analyzing the first image and the second image using an image recognition process to identify one or more outlier garments, and implementing a responsive action in response to identifying the one or more outlier garments.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a washing machine appliance according to an exemplary embodiment of the present subject matter with a door of the exemplary washing machine appliance shown in a closed position.

FIG. 2 provides a perspective view of the exemplary washing machine appliance of FIG. 1 with the door of the exemplary washing machine appliance shown in an open position.

FIG. 3 provides a side cross-sectional view of the exemplary washing machine appliance of FIG. 1.

FIG. 4 illustrates a method for operating a washing machine appliance in accordance with one embodiment of the present disclosure.

FIG. 5 provides a flow diagram illustrating an exemplary process for identifying articles of clothing that may result in color contamination of a wash load and implementing a responsive action according to an exemplary embodiment of the present subject matter.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

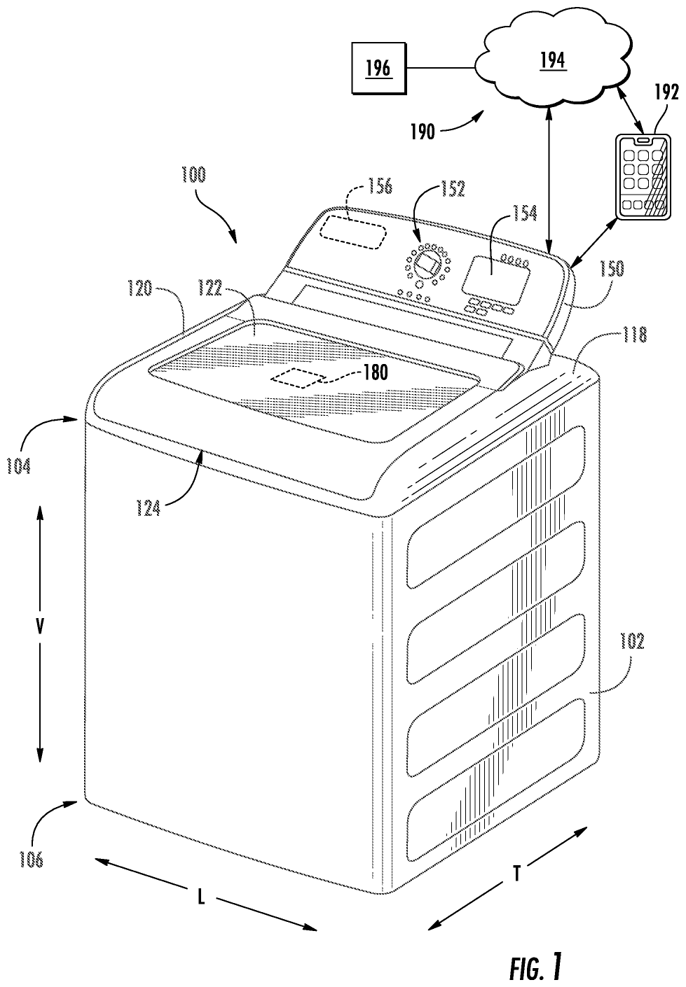

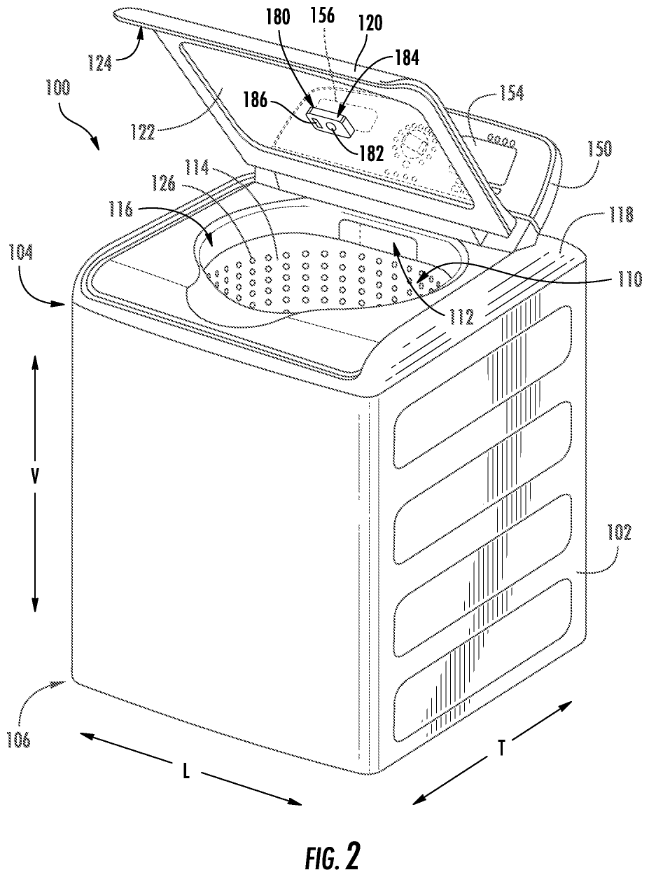

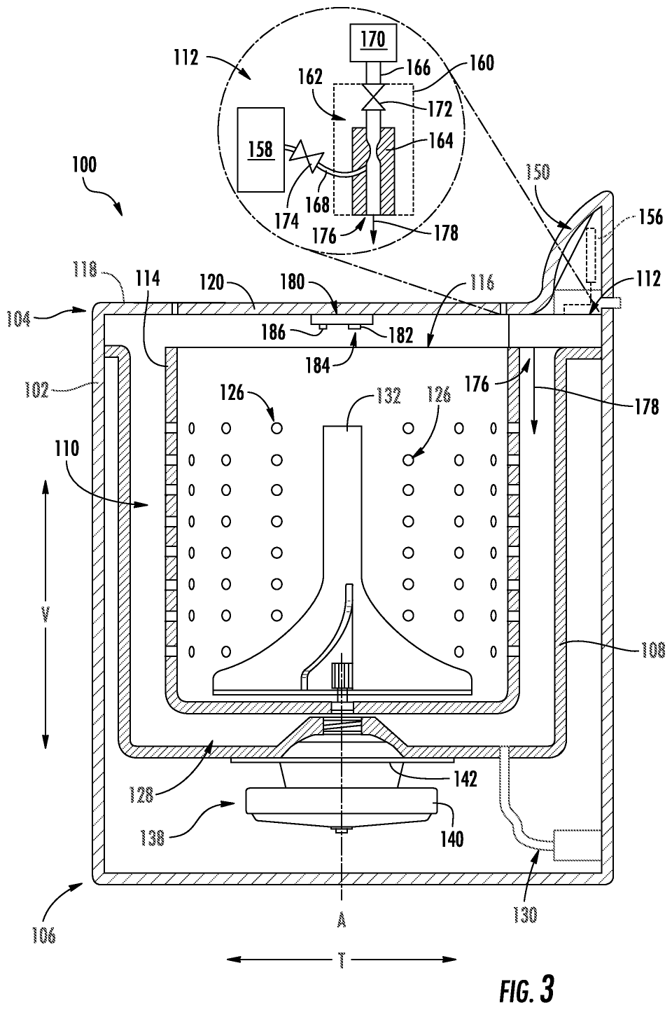

FIGS. 1 through 3 illustrate an exemplary embodiment of a vertical axis washing machine appliance 100. Specifically, FIGS. 1 and 2 illustrate perspective views of washing machine appliance 100 in a closed and an open position, respectively. FIG. 3 provides a side cross-sectional view of washing machine appliance 100. Washing machine appliance 100 generally defines a vertical direction V, a lateral direction L, and a transverse direction T, each of which is mutually perpendicular, such that an orthogonal coordinate system is generally defined.

While described in the context of a specific embodiment of vertical axis washing machine appliance 100, it should be appreciated that vertical axis washing machine appliance 100 is provided by way of example only. It will be understood that aspects of the present subject matter may be used in any other suitable washing machine appliance, such as a horizontal axis washing machine appliance. Indeed, modifications and variations may be made to washing machine appliance 100, including different configurations, different appearances, and/or different features while remaining within the scope of the present subject matter.

Washing machine appliance 100 has a cabinet 102 that extends between a top portion 104 and a bottom portion 106 along the vertical direction V, between a first side (left) and a second side (right) along the lateral direction L, and between a front and a rear along the transverse direction T. As best shown in FIG. 3, a wash tub 108 is positioned within cabinet 102, defines a wash chamber 110, and is generally configured for retaining wash fluids during an operating cycle. Washing machine appliance 100 further includes a primary dispenser or dispensing assembly 112 (FIG. 2) for dispensing wash fluid into wash tub 108.

In addition, washing machine appliance 100 includes a wash basket 114 that is positioned within wash tub 108 and generally defines an opening 116 for receipt of articles for washing. More specifically, wash basket 114 is rotatably mounted within wash tub 108 such that it is rotatable about an axis of rotation A. According to the illustrated embodiment, the axis of rotation A is substantially parallel to the vertical direction V. In this regard, washing machine appliance 100 is generally referred to as a “vertical axis” or “top load” washing machine appliance 100. However, it should be appreciated that aspects of the present subject matter may be used within the context of a horizontal axis or front load washing machine appliance as well.

As illustrated, cabinet 102 of washing machine appliance 100 has a top panel 118. Top panel 118 defines an opening (FIG. 2) that coincides with opening 116 of wash basket 114 to permit a user access to wash basket 114. Washing machine appliance 100 further includes a door 120 which is rotatably mounted to top panel 118 to permit selective access to opening 116. In particular, door 120 selectively rotates between the closed position (as shown in FIGS. 1 and 3) and the open position (as shown in FIG. 2). In the closed position, door 120 inhibits access to wash basket 114. Conversely, in the open position, a user can access wash basket 114. A window 122 in door 120 permits viewing of wash basket 114 when door 120 is in the closed position, e.g., during operation of washing machine appliance 100. Door 120 also includes a handle 124 that, e.g., a user may pull and/or lift when opening and closing door 120. Further, although door 120 is illustrated as mounted to top panel 118, door 120 may alternatively be mounted to cabinet 102 or any other suitable support.

As best shown in FIGS. 2 and 3, wash basket 114 further defines a plurality of perforations 126 to facilitate fluid communication between an interior of wash basket 114 and wash tub 108. In this regard, wash basket 114 is spaced apart from wash tub 108 to define a space for wash fluid to escape wash chamber 110. During a spin cycle, wash fluid within articles of clothing and within wash chamber 110 is urged through perforations 126 wherein it may collect in a sump 128 defined by wash tub 108. Washing machine appliance 100 further includes a pump assembly 130 (FIG. 3) that is located beneath wash tub 108 and wash basket 114 for gravity assisted flow when draining wash tub 108.

An impeller or agitation element 132 (FIG. 3), such as a vane agitator, impeller, auger, oscillatory basket mechanism, or some combination thereof is disposed in wash basket 114 to impart an oscillatory motion to articles and liquid in wash basket 114. More specifically, agitation element 132 extends into wash basket 114 and assists agitation of articles disposed within wash basket 114 during operation of washing machine appliance 100, e.g., to facilitate improved cleaning. In different embodiments, agitation element 132 includes a single action element (i.e., oscillatory only), a double action element (oscillatory movement at one end, single direction rotation at the other end) or a triple action element (oscillatory movement plus single direction rotation at one end, single direction rotation at the other end). As illustrated in FIG. 3, agitation element 132 and wash basket 114 are oriented to rotate about axis of rotation A (which is substantially parallel to vertical direction V).

As best illustrated in FIG. 3, washing machine appliance 100 includes a drive assembly or motor assembly 138 in mechanical communication with wash basket 114 to selectively rotate wash basket 114 (e.g., during an agitation or a rinse cycle of washing machine appliance 100). In addition, motor assembly 138 may also be in mechanical communication with agitation element 132. In this manner, motor assembly 138 may be configured for selectively rotating or oscillating wash basket 114 and/or agitation element 132 during various operating cycles of washing machine appliance 100.

More specifically, motor assembly 138 may generally include one or more of a drive motor 140 and a transmission assembly 142, e.g., such as a clutch assembly, for engaging and disengaging wash basket 114 and/or agitation element 132. According to the illustrated embodiment, drive motor 140 is a brushless DC electric motor, e.g., a pancake motor. However, according to alternative embodiments, drive motor 140 may be any other suitable type or configuration of motor. For example, drive motor 140 may be an AC motor, an induction motor, a permanent magnet synchronous motor, or any other suitable type of motor. In addition, motor assembly 138 may include any other suitable number, types, and configurations of support bearings or drive mechanisms.

Referring still to FIGS. 1 through 3, a control panel 150 with at least one input selector 152 (FIG. 1) extends from top panel 118. Control panel 150 and input selector 152 collectively form a user interface input for operator selection of machine cycles and features. A display 154 of control panel 150 indicates selected features, operation mode, a countdown timer, and/or other items of interest to appliance users regarding operation.

Operation of washing machine appliance 100 is controlled by a controller or processing device 156 that is operatively coupled to control panel 150 for user manipulation to select washing machine cycles and features. In response to user manipulation of control panel 150, controller 156 operates the various components of washing machine appliance 100 to execute selected machine cycles and features. According to an exemplary embodiment, controller 156 may include a memory and microprocessor, such as a general or special purpose microprocessor operable to execute programming instructions or micro-control code associated with methods described herein. Alternatively, controller 156 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software. Control panel 150 and other components of washing machine appliance 100 may be in communication with controller 156 via one or more signal lines or shared communication busses.

During operation of washing machine appliance 100, laundry items are loaded into wash basket 114 through opening 116, and washing operation is initiated through operator manipulation of input selectors 152. Wash basket 114 is filled with water and detergent and/or other fluid additives via primary dispenser 112. One or more valves can be controlled by washing machine appliance 100 to provide for filling wash tub 108 and wash basket 114 to the appropriate level for the amount of articles being washed and/or rinsed. By way of example for a wash mode, once wash basket 114 is properly filled with fluid, the contents of wash basket 114 can be agitated (e.g., with agitation element 132 as discussed previously) for washing of laundry items in wash basket 114.

Referring again to FIGS. 2 and 3, dispensing assembly 112 of washing machine appliance 100 will be described in more detail. As explained briefly above, dispensing assembly 112 may generally be configured to dispense wash fluid to facilitate one or more operating cycles or phases of an operating cycle (e.g., such as a wash cycle or a rinse cycle). The terms “wash fluid” and the like may be used herein to generally refer to a liquid used for washing and/or rinsing clothing or other articles. For example, the wash fluid is typically made up of water that may include other additives such as detergent, fabric softener, bleach, or other suitable treatments (including combinations thereof). More specifically, the wash fluid for a wash cycle may be a mixture of water, detergent, and/or other additives, while the wash fluid for a rinse cycle may be water only.

As best shown schematically in FIG. 3, dispensing assembly 112 may generally include a bulk storage tank or bulk reservoir 158 and a dispenser box 160. More specifically, bulk reservoir 158 may be positioned under top panel 118 and defines an additive reservoir for receiving and storing wash additive. More specifically, according to the illustrated embodiment, bulk reservoir 158 may contain a bulk volume of wash additive (such as detergent or other suitable wash additives) that is sufficient for a plurality of wash cycles of washing machine appliance 100, such as no less than twenty wash cycles, no less than fifty wash cycles, etc. As a particular example, bulk reservoir 158 is configured for containing no less than twenty fluid ounces, no less than three-quarters of a gallon, or about one gallon of wash additive.

As will be described in detail below, dispensing assembly 112 may include features for drawing wash additive from bulk reservoir 158 and mixing it with water prior to directing the mixture into wash tub 108 to facilitate a cleaning operation. By contrast, dispensing assembly 112 is also capable of dispensing water only. Thus, dispensing assembly 112 may automatically dispense the desired amount of water with or without a desired amount of wash additive such that a user can avoid filling dispenser box 160 with detergent before each operation of washing machine appliance 100.

For example, as best shown in FIG. 3, washing machine appliance 100 includes an aspirator assembly 162, which is a Venturi-based dispensing system that uses a flow of water to create suction within a Venturi tube to draw in wash additive from bulk reservoir 158 which mixes with the water and is dispensed into wash tub 108 as a concentrated wash fluid preferably having a target volume of wash additive. After the target volume of wash additive is dispensed into wash tub 108, additional water may be provided into wash tub 108 as needed to fill to the desired wash volume. It should be appreciated that the target volume may be preprogrammed in controller 156 according to the selected operating cycle or parameters, may be set by a user, or may be determined in any other suitable manner.

As illustrated, aspirator assembly 162 includes a Venturi pump 164 that is fluidly coupled to both a water supply conduit 166 and a suction line 168. As illustrated, water supply conduit 166 may provide fluid communication between a water supply source 170 (such as a municipal water supply) and a water inlet of Venturi pump 164. In addition, washing machine appliance 100 includes a water fill valve or water control valve 172 which is operably coupled to water supply conduit 166 and is communicatively coupled to controller 156. In this manner, controller 156 may regulate the operation of water control valve 172 to regulate the amount of water that passes through aspirator assembly 162 and into wash tub 108.

In addition, suction line 168 may provide fluid communication between bulk reservoir 158 and Venturi pump 164 (e.g., via a suction port defined on Venturi pump 164). Notably, as a flow of water is supplied through Venturi pump 164 to wash tub 108, the flowing water creates a negative pressure within suction line 168. This negative pressure may draw in wash additive from bulk reservoir 158. When certain conditions exist, the amount of wash additive dispensed is roughly proportional to the amount of time water is flowing through Venturi pump 164.

Referring still to FIG. 3, aspirator assembly 162 may further include a suction valve 174 that is operably coupled to suction line 168 to control the flow of wash additive through suction line 168 when desired. For example, suction valve 174 may be a solenoid valve that is communicatively coupled with controller 156. Controller 156 may selectively open and close suction valve 174 to allow wash additive to flow from bulk reservoir 158 through additive suction valve 174. For example, during a rinse cycle where only water is desired, suction valve 174 may be closed to prevent wash additive from being dispensed through suction valve 174. In some embodiments, suction valve 174 is selectively controlled based on at least one of the selected wash cycle, the soil level of the articles to be washed, and the article type. According to still other embodiments, no suction valve 174 is needed at all and alternative means for preventing the flow of wash additive may be used or other water regulating valves may be used to provide water into wash tub 108.

Washing machine appliance 100, or more particularly, dispensing assembly 112, generally includes a discharge nozzle 176 for directing a flow of wash fluid (e.g., identified herein generally by reference numeral 178) into wash chamber 108. In this regard, discharge nozzle 176 may be positioned above wash tub proximate a rear of opening 116 defined through top panel 118. Dispensing assembly 112 may be regulated by controller 156 to discharge wash fluid 178 through discharge nozzle 176 at the desired flow rates, volumes, and/or detergent concentrations to facilitate various operating cycles, e.g., such as wash or rinse cycles.

Although water supply conduit 166, water supply source 170, discharge nozzle 176, and water control valve 172 are all described and illustrated herein in the singular form, it should be appreciated that these terms may be used herein generally to describe a supply plumbing for providing hot and/or cold water into wash chamber 110. In this regard, water supply conduit 166 may include separate conduits for receiving hot and cold water, respectively. Similarly, water supply source 170 may include both hot- and cold-water supplies regulated by dedicated valves. In addition, washing machine appliance 100 may include one or more pressure sensors (not shown) for detecting the amount of water and or clothes within wash tub 108. For example, the pressure sensor may be operably coupled to a side of tub 108 for detecting the weight of wash tub 108, which controller 156 may use to determine a volume of water in wash chamber 110 and a subwasher load weight.

After wash tub 108 is filled and the agitation phase of the wash cycle is completed, wash basket 114 can be drained, e.g., by drain pump assembly 130. Laundry articles can then be rinsed by again adding fluid to wash basket 114 depending on the specifics of the cleaning cycle selected by a user. The impeller or agitation element 132 may again provide agitation within wash basket 114. One or more spin cycles may also be used as part of the cleaning process. In particular, a spin cycle may be applied after the wash cycle and/or after the rinse cycle in order to wring wash fluid from the articles being washed. During a spin cycle, wash basket 114 is rotated at relatively high speeds to help wring fluid from the laundry articles through perforations 126. During or prior to the spin cycle, drain pump assembly 138 may operate to discharge wash fluid from wash tub 108, e.g., to an external drain. After articles disposed in wash basket 114 are cleaned and/or washed, the user can remove the articles from wash basket 114, e.g., by reaching into wash basket 114 through opening 116.

Referring now specifically to FIGS. 2 and 3, washing machine appliance 100 may further include a camera assembly 180 that is generally positioned and configured for obtaining images within wash chamber 110 of washing machine appliance 100. Specifically, according to the illustrated embodiment, camera assembly 180 may include a camera 182 mounted to an underside of door 120 of washing machine appliance 100. In this manner, when door 120 is in the closed position, camera 182 may be positioned over wash chamber 110 and may be oriented for obtaining images within wash chamber 110. Specifically, camera 182 is mounted such that is faces toward a bottom side of wash tub 108. In this manner, camera 182 can take unobstructed images or video of an inside of wash chamber 110, e.g., including images of wash basket 114 and discharge nozzle 176.

It should be appreciated that camera assembly 180 may include any suitable number, type, size, and configuration of camera(s) 182 for obtaining images of wash chamber 110. In general, cameras 182 may include a lens 184 that is constructed from a clear hydrophobic material or which may otherwise be positioned behind a hydrophobic clear lens. So positioned, camera assembly 180 may obtain one or more images or videos within wash chamber 110, as described in more detail below. It should be appreciated that other locations for mounting camera assembly 180 are possible, such as below or adjacent a discharge nozzle 176 of washing machine appliance 100.

Referring still to FIGS. 2 through 3, washing machine appliance 100 may further include a tub light 186 that is positioned within cabinet 102 or wash chamber 110 for selectively illuminating wash chamber 110 and the load of clothes positioned therein. Specifically, as shown in FIG. 2, tub light 186 may be integrated into camera assembly 180 and may be positioned immediately adjacent camera 182. According to still other embodiments, tub light 186 may be positioned at any other suitable location within cabinet 102. It should be appreciated that according to alternative embodiments, washing machine appliance 100 may include any other camera or system of imaging devices for obtaining images of the load of clothes. In addition, these cameras may be positioned at any suitable location within cabinet 102, may include any suitable lighting features, and may utilize any suitable photography or imaging technology.

Notably, controller 156 of washing machine appliance 100 (or any other suitable dedicated controller) may be communicatively coupled to camera assembly 180, tub light 186, and other components of washing machine appliance 100. As explained in more detail below, controller 156 may be programmed or configured for analyzing the images obtained by camera assembly 180, e.g., in order to determine the level of water or wash fluid within wash chamber 110 or other cycle information, and may use this information to make informed decisions regarding the operation of washing machine appliance 100.

Referring still to FIG. 1, a schematic diagram of an external communication system 190 will be described according to an exemplary embodiment of the present subject matter. In general, external communication system 190 is configured for permitting interaction, data transfer, and other communications between washing machine appliance 100 and one or more external devices. For example, this communication may be used to provide and receive operating parameters, user instructions or notifications, performance characteristics, user preferences, or any other suitable information for improved performance of washing machine appliance 100. In addition, it should be appreciated that external communication system 190 may be used to transfer data or other information to improve performance of one or more external devices or appliances and/or improve user interaction with such devices.

For example, external communication system 190 permits controller 156 of washing machine appliance 100 to communicate with a separate device external to washing machine appliance 100, referred to generally herein as an external device 192. As described in more detail below, these communications may be facilitated using a wired or wireless connection, such as via a network 194. In general, external device 192 may be any suitable device separate from washing machine appliance 100 that is configured to provide and/or receive communications, information, data, or commands from a user. In this regard, external device 192 may be, for example, a personal phone, a smartphone, a tablet, a laptop or personal computer, a wearable device, a smart home system, or another mobile or remote device.

In addition, a remote server 196 may be in communication with washing machine appliance 100 and/or external device 192 through network 194. In this regard, for example, remote server 196 may be a cloud-based server 196, and is thus located at a distant location, such as in a separate state, country, etc. According to an exemplary embodiment, external device 192 may communicate with a remote server 196 over network 194, such as the Internet, to transmit/receive data or information, provide user inputs, receive user notifications or instructions, interact with or control washing machine appliance 100, etc. In addition, external device 192 and remote server 196 may communicate with washing machine appliance 100 to communicate similar information.

In general, communication between washing machine appliance 100, external device 192, remote server 196, and/or other user devices or appliances may be carried using any type of wired or wireless connection and using any suitable type of communication network, non-limiting examples of which are provided below. For example, external device 192 may be in direct or indirect communication with washing machine appliance 100 through any suitable wired or wireless communication connections or interfaces, such as network 194. For example, network 194 may include one or more of a local area network (LAN), a wide area network (WAN), a personal area network (PAN), the Internet, a cellular network, any other suitable short- or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), and/or protection schemes (e.g., VPN, secure HTTP, SSL).

External communication system 190 is described herein according to an exemplary embodiment of the present subject matter. However, it should be appreciated that the exemplary functions and configurations of external communication system 190 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

While described in the context of a specific embodiment of vertical axis washing machine appliance 100, using the teachings disclosed herein it will be understood that vertical axis washing machine appliance 100 is provided by way of example only. Other washing machine appliances having different configurations, different appearances, and/or different features may also be utilized with the present subject matter as well, e.g., horizontal axis washing machine appliances. In addition, aspects of the present subject matter may be utilized in a combination washer/dryer appliance.

Now that the construction of washing machine appliance 100 and the configuration of controller 156 according to exemplary embodiments have been presented, an exemplary method 200 of operating a washing machine appliance will be described. Although the discussion below refers to the exemplary method 200 of operating washing machine appliance 100, one skilled in the art will appreciate that the exemplary method 200 is applicable to the operation of a variety of other washing machine appliances, such as horizontal axis washing machine appliances. In exemplary embodiments, the various method steps as disclosed herein may be performed by controller 156 or a separate, dedicated controller.

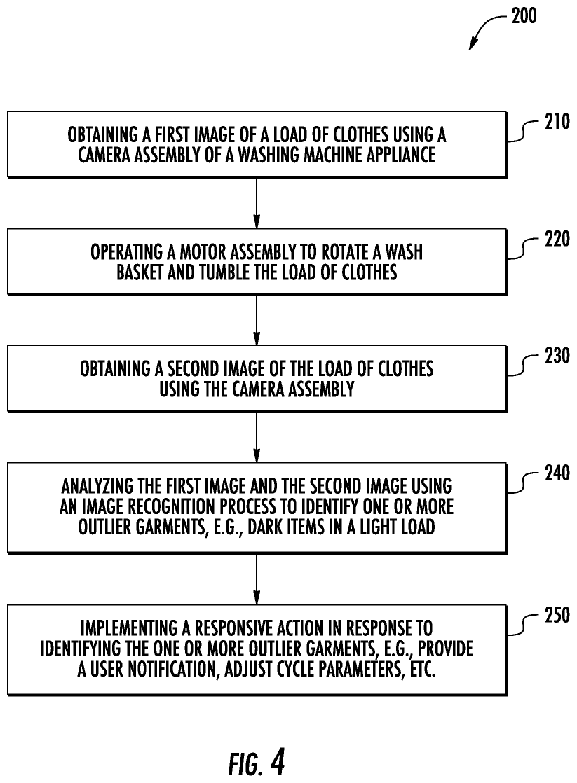

Referring now to FIG. 4, method 200 includes, at step 210, obtaining a first image of a load of clothes using a camera assembly of a washing machine appliance. For example, continuing the example from above, camera assembly 180 may be used to take one or more images within wash basket 114. It should be appreciated that obtaining a first image may include obtaining more than one images, a series of frames, a video, or any other suitable visual representation of the load of clothes using camera assembly 180.

As explained in more detail below, the first image may be used to monitor the load of clothes and identify one or more outlier garments. As used herein, the terms “outlier garment” and the like may be used generally refer to any items of clothing or other objects that are present within a load of clothes and present a risk of color contamination of the load of clothes. For example, if the load of clothes is primarily white shirts or bright whites and blue jeans are present within the load of clothes, color bleed from the blue jeans may permanently stain or discolor the lighter colored garments within the load. Accordingly, the blue jeans may be referred to as an outlier garment within the load.

Notably, obtaining and analyzing a single image of a load of clothes may not provide a sufficient evaluation of the load of clothes for the purpose of identifying an outlier garment. For example, the outlier garment may be positioned at the bottom of wash basket 114 and may be covered by the remainder of the load, e.g., thereby concealing the outlier garment from the view of camera assembly 180. Thus, for example, if blue jeans are positioned below or concealed within the load of white shirts, the blue jeans may not be identifiable from the first image. Accordingly, aspects of the present subject matter are directed to obtaining a better visual representation of the entire load of clothes, e.g., to better identify color contamination issues and outlier garments.

Specifically, step 220 may generally include operating a motor assembly to rotate a wash basket and tumble the load of clothes. Thus, according to exemplary embodiments, motor assembly 138 may operate to rotate wash basket 114 and/or operate agitation element 132 to tumble the load of clothes within wash chamber 110. It should be appreciated that any suitable agitation profile, intensity, and duration may be used to tumble the load of clothes. For example, motor assembly 138 may be operated until a turnover condition of the load of clothes has been satisfied, after which the motor assembly may be stopped and the method may proceed.

In general, the “turnover condition” may generally refer to any condition or set of parameters related to the operation of motor assembly 180 or the rotation of wash basket 114 which is sufficient to reposition or shuffle the load of clothes within wash basket 114. For example, determining that the turnover condition of the load of clothes has been satisfied may include determining that the motor assembly has been operating for a predetermined amount of time. In this regard, for example, the predetermined amount of time may be between about 1 second and 30 seconds, between about 2 seconds and 15 seconds, or about 5 seconds.

According to still other embodiments, determining that the turnover condition of the load of clothes has been satisfied may include analyzing one or more images of the load of clothes to determine that sufficient shuffling or movement of specific garments has occurred. Such analysis may be performed in real time while the motor assembly 180 is rotating or during intermittent pauses in the wash basket rotation. In addition, such image analysis may include any of the image analysis techniques described below.

Step 230 may generally include obtaining a second image of the load of clothes using the camera assembly. In this regard, similar to step 210, camera assembly 180 may obtain the second image of the load of clothes within wash basket 114. Although the description herein refers to obtaining a first image (e.g., at step 210) and a second image (e.g., at step 230), it should be appreciated that aspects of the present subject matter are intended to include any suitable number and frequency of images or video obtained before and after the tumbling process is performed at step 220. In this regard, for example, method 200 may include continuously monitoring a live stream or video feed from camera assembly 180 during the tumbling process. In addition, method 200 may include obtaining more than two images, e.g., for a more thorough analysis of the load of clothes.

In addition, it should be appreciated that the images obtained by camera assembly 180 may vary in number, frequency, angle, resolution, detail, etc. in order to improve the clarity of the load of clothes. In addition, according to exemplary embodiments, controller 156 may be configured for illuminating the tub using tub light 186 just prior to obtaining images. The obtaining images may also be cropped in any suitable manner for improved focus on desired portions within wash basket 114. For example, the first image and the second image may be cropped to focus on a bottom center of wash basket 114, e.g., covering a predetermined area of wash basket 114 centered on the bottom center. In this regard, for example, the predetermined coverage area may be about 50%, or about 75%, or about 90% of the wash chamber 110 when viewed from above.

Step 240 generally includes analyzing the first image and the second image using an image recognition process to identify one or more outlier garments. In this regard, as explained above, the outlier garment may be a dark item within a light load. Step 240 may include analyzing the first and second image (e.g., or any other visual representation of the load of clothes obtained by camera assembly 180) to identify such outlier garments. If analysis of any of the images of the load of clothes reveals the presence of an outlier garment, corrective action may be taken, as explained in more detail below.

According to exemplary embodiments, the image analysis may use any suitable image processing technique, image recognition process, etc. As used herein, the terms “image analysis” and the like may be used generally to refer to any suitable method of observation, analysis, image decomposition, feature extraction, image classification, etc. of one or more images, videos, or other visual representations of an object. As explained in more detail below, this image analysis may include the implementation of image processing techniques, image recognition techniques, or any suitable combination thereof. In this regard, the image analysis may use any suitable image analysis software or algorithm to constantly or periodically monitor the wash basket 114 or the load of clothes contained therein. It should be appreciated that this image analysis or processing may be performed locally (e.g., by controller 134) or remotely (e.g., by offloading image data to a remote server or network).

Specifically, the analysis of the one or more images may include implementation of an image processing algorithm. As used herein, the terms “image processing” and the like are generally intended to refer to any suitable methods or algorithms for analyzing images that do not rely on artificial intelligence or machine learning techniques (e.g., in contrast to the machine learning image recognition processes described below). For example, the image processing algorithm may rely on image differentiation, e.g., such as a pixel-by-pixel comparison of two sequential images. This comparison may help identify substantial differences between the sequentially obtained images, e.g., to identify movement, the presence of a particular object, the existence of a certain condition, etc. For example, one or more reference images may be obtained when a particular condition exists, and these references images may be stored for future comparison with images obtained during appliance operation. Similarities and/or differences between the reference image and the obtained image may be used to extract useful information for improving appliance performance.

According to exemplary embodiments, the image analysis performed at step 240 may generally include generating or preparing a color histogram of the images. In this regard, color histogram may generally include a representation of the distribution of colors with an image. For example, the color histogram may include a number of pixels within each image that have colors within a specific range. After preparing the color histogram for each image, the pixel color identification may be compared to a predetermined color ranges or thresholds, e.g., such as ranges associated with dark items, light items, white items, etc. By comparing the pixels from the color histogram with predetermined color values, outlier garments may be identified.

Notably, it should be appreciated that outlier garments may generally be defined relative to the remainder of the load. In this regard, a dark black sock may be an outlier garment when placed within a load of white shirts but may not be an outlier garment when placed within a load of dark gray pants. According to exemplary embodiments, a difference between the darkness level of the potential outlier garment and an average darkness level of the remainder of the load may be used to determine whether responsive action should be taken. In this regard, for example, analyzing the images may include identifying and outlier darkness level of the one or more outlier garments and a load darkness level of the remainder of the load of clothes. This analysis may further include determining that a difference between the outlier darkness level and the load darkness level exceeds a predetermined threshold.

According to exemplary embodiments, image processing may include blur detection algorithms that are generally intended to compute, measure, or otherwise determine the amount of blur in an image. For example, these blur detection algorithms may rely on focus measure operators, the Fast Fourier Transform along with examination of the frequency distributions, determining the variance of a Laplacian operator, or any other methods of blur detection known by those having ordinary skill in the art. In addition, or alternatively, the image processing algorithms may use other suitable techniques for recognizing or identifying items or objects, such as edge matching or detection, divide-and-conquer searching, greyscale matching, histograms of receptive field responses, or another suitable routine (e.g., executed at the controller 156 based on one or more captured images from one or more cameras). Other image processing techniques are possible and within the scope of the present subject matter. The processing algorithm may further include measures for isolating or eliminating noise in the image comparison, e.g., due to image resolution, data transmission errors, inconsistent lighting, or other imaging errors. By eliminating such noise, the image processing algorithms may improve accurate object detection, avoid erroneous object detection, and isolate the important object, region, or pattern within an image.

In addition to the image processing techniques described above, the image analysis may include utilizing artificial intelligence (“AI”), such as a machine learning image recognition process, a neural network classification module, any other suitable artificial intelligence (AI) technique, and/or any other suitable image analysis techniques, examples of which will be described in more detail below. Moreover, each of the exemplary image analysis or evaluation processes described below may be used independently, collectively, or interchangeably to extract detailed information regarding the images being analyzed to facilitate performance of one or more methods described herein or to otherwise improve appliance operation. According to exemplary embodiments, any suitable number and combination of image processing, image recognition, or other image analysis techniques may be used to obtain an accurate analysis of the obtained images.

In this regard, the image recognition process may use any suitable artificial intelligence technique, for example, any suitable machine learning technique, or for example, any suitable deep learning technique. According to an exemplary embodiment, the image recognition process may include the implementation of a form of image recognition called region based convolutional neural network (“R-CNN”) image recognition. Generally speaking, R-CNN may include taking an input image and extracting region proposals that include a potential object or region of an image. In this regard, a “region proposal” may be one or more regions in an image that could belong to a particular object or may include adjacent regions that share common pixel characteristics. A convolutional neural network is then used to compute features from the region proposals and the extracted features will then be used to determine a classification for each particular region.

According to still other embodiments, an image segmentation process may be used along with the R-CNN image recognition. In general, image segmentation creates a pixel-based mask for each object in an image and provides a more detailed or granular understanding of the various objects within a given image. In this regard, instead of processing an entire image—i.e., a large collection of pixels, many of which might not contain useful information—image segmentation may involve dividing an image into segments (e.g., into groups of pixels containing similar attributes) that may be analyzed independently or in parallel to obtain a more detailed representation of the object or objects in an image. This may be referred to herein as “mask R-CNN” and the like, as opposed to a regular R-CNN architecture. For example, mask R-CNN may be based on fast R-CNN which is slightly different than R-CNN. For example, R-CNN first applies a convolutional neural network (“CNN”) and then allocates it to zone recommendations on the covn5 property map instead of the initially split into zone recommendations. In addition, according to exemplary embodiments, standard CNN may be used to obtain, identify, or detect any other qualitative or quantitative data related to one or more objects or regions within the one or more images. In addition, a K-means algorithm may be used.

According to still other embodiments, the image recognition process may use any other suitable neural network process while remaining within the scope of the present subject matter. For example, the step of analyzing the one or more images may include using a deep belief network (“DBN”) image recognition process. A DBN image recognition process may generally include stacking many individual unsupervised networks that use each network's hidden layer as the input for the next layer. According to still other embodiments, the step of analyzing one or more images may include the implementation of a deep neural network (“DNN”) image recognition process, which generally includes the use of a neural network (computing systems inspired by the biological neural networks) with multiple layers between input and output. Other suitable image recognition processes, neural network processes, artificial intelligence analysis techniques, and combinations of the above described or other known methods may be used while remaining within the scope of the present subject matter.

In addition, it should be appreciated that various transfer techniques may be used but use of such techniques is not required. If using transfer techniques learning, a neural network architecture may be pretrained such as VGG16/VGG19/ResNet50 with a public dataset then the last layer may be retrained with an appliance specific dataset. In addition, or alternatively, the image recognition process may include detection of certain conditions based on comparison of initial conditions, may rely on image subtraction techniques, image stacking techniques, image concatenation, etc. For example, the subtracted image may be used to train a neural network with multiple classes for future comparison and image classification.

It should be appreciated that the machine learning image recognition models may be actively trained by the appliance with new images, may be supplied with training data from the manufacturer or from another remote source, or may be trained in any other suitable manner. For example, according to exemplary embodiments, this image recognition process relies at least in part on a neural network trained with a plurality of images of the appliance in different configurations, experiencing different conditions, or being interacted with in different manners. This training data may be stored locally or remotely and may be communicated to a remote server for training other appliances and models. According to exemplary embodiments, it should be appreciated that the machine learning models may include supervised and/or unsupervised models and methods. In this regard, for example, supervised machine learning methods (e.g., such as targeted machine learning) may help identify problems, anomalies, or other occurrences which have been identified and trained into the model. By contrast, unsupervised machine learning methods may be used to detect clusters of potential failures, similarities among data, event patterns, abnormal concentrations of a phenomenon, etc.

It should be appreciated that image processing and machine learning image recognition processes may be used together to facilitate improved image analysis, object detection, or to extract other useful qualitative or quantitative data or information from the one or more images that may be used to improve the operation or performance of the appliance. Indeed, the methods described herein may use any or all of these techniques interchangeably to improve image analysis process and facilitate improved appliance performance and consumer satisfaction. The image processing algorithms and machine learning image recognition processes described herein are only exemplary and are not intended to limit the scope of the present subject matter in any manner.

Step 250 may generally include implementing a responsive action in response to identifying the one or more outlier garments. In this regard, if the analysis performed at step 240 reveals one or more outlier garments within the load of clothes such that a likelihood of color contamination is possible, method 200 may include automatically implementing responsive action to address the issue. For example, according to an exemplary embodiment, implementing the responsive action may include adjusting at least one operating parameter of the washing machine appliance 100. For example, method 200 may include stopping the current operating cycle, operating a drain pump assembly 130 to drain wash tub 108, and/or preventing further operating cycles of washing machine appliance 100 until the user has been notified, the color contamination issue has been addressed, etc.

According to exemplary embodiments, washing machine appliance 100 may include a water supply (e.g., including water supply source 170 and water control valve 172), and implementing the responsive action may include lowering the temperature of the flow of wash fluid into wash tub 108. In this regard, for example, lower temperature water during the wash cycle may reduce the likelihood of colors bleeding from the outlier garments. According to still other embodiments, implementing the responsive action may include operating water supply to lower the level of wash fluid within wash tub 108. Other adjustments to water supply are possible and within scope the present subject matter.

According to exemplary embodiments, implementing the responsive action may also include adjusting a cycle time of a wash cycle, adjusting a spin speed of a wash cycle, or adjusting any other suitable operating parameters. For example, implementing a responsive action may include adjusting an agitation profile, intensity, duration, etc. Other suitable operating parameter adjustments are possible and within the scope present subject matter.

In addition, or alternatively, step 250 of implementing a responsive action may include providing a user notification that an outlier garments has been detected within the load of clothes. In addition, this user notification may include useful information such as an image of the load of clothes, e.g., with the potential outlier garments highlighted or emphasized for user convenience. It should be appreciated that the user notification may be provided to the user from any suitable source and in any suitable manner. For example, according to exemplary embodiments, the user notification may be provided through control panel 150 so that the user may be aware of the issue (e.g., such as via an illuminated warning indicator, an image displayed on a screen, etc.). In addition, or alternatively, controller 156 may be configured to provide a user notification to a remote device, such as remote device 192 via a network 194. For example, the user notification may include a pop-up notification on a user's cell phone or other remote device and may include a display of the one or more images of the load of clothes.

Notably, method 200 may further include proceeding as usual if no outlier garments are detected. In this regard, method 200 may include analyzing the first image and the second image using an image recognition process to determine that the load of clothes does not contain the one or more outlier garments. Upon making such a determination, the method may include proceeding with an operating cycle according to existing operating parameters.

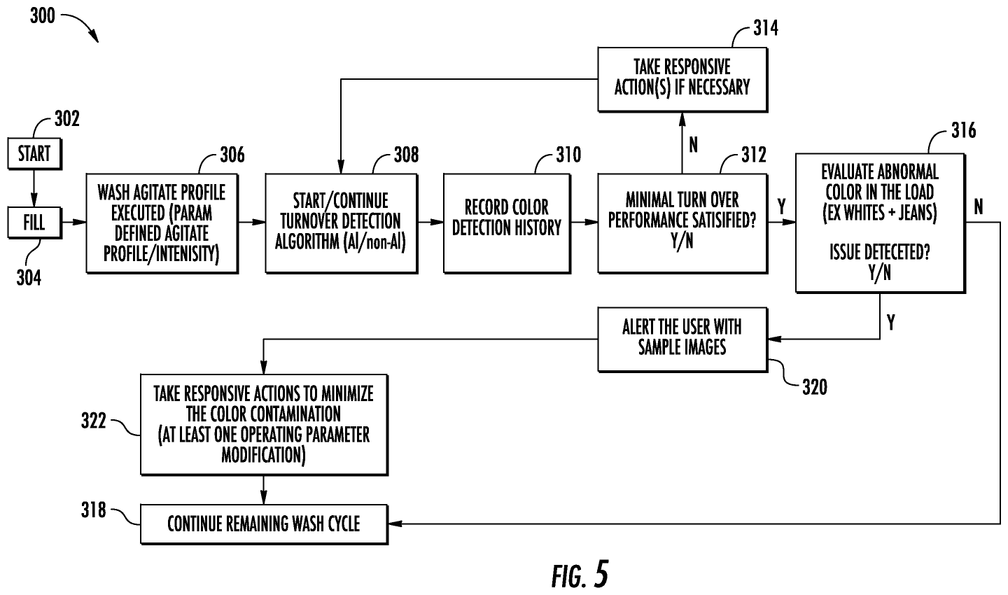

Referring now briefly to FIG. 5, an exemplary flow diagram of a color contamination detection method 300 that may be implemented by washing machine appliance 100 will be described according to an exemplary embodiment of the present subject matter. According to exemplary embodiments, method 300 may be similar to or interchangeable with method 200 and may be implemented by controller 156 of washing machine appliance 100. As shown, at step 302, controller 156 may first start an operating cycle of a washing machine appliance.

Step 304 may include initiating a fill process and step 306 may include starting a wash cycle by implementing a predetermined agitation profile. At step 308, a turnover detection algorithm may be initiated. In addition, step 310 may include obtaining images, analyzing images, and recording color contamination issues within the load of clothes. Step 312 may include determining whether a minimal turnover condition has been satisfied. If sufficient turnover has not been achieved (e.g., such that dark garments may still be buried underneath white clothes), step 314 may include continuing the tumbling process or engaging the user to take other corrective action.

If step 312 results in a determination that the minimal turnover conditions have been satisfied, step 316 may include evaluating the images and color detection history obtained at step 310 to determine whether there is an outlier garment or to identify any other color contamination issue. If no color contamination issue is detected, the process may proceed to step 318 where the remainder of the wash cycle is performed with predetermined parameters. By contrast, if step 316 results in a determination that there may be a color contamination issue, the user may be provided with the obtained images (e.g., via display 150 or remote device 192). The appliance may then seek user confirmation as to whether the operating cycle should proceed, whether it should be canceled to allow the user to remove the outlier garment, etc. In addition, or alternatively, step 322 may include taking other responsive actions to reduce the likelihood of color contamination. For example, these responsive actions may include adjusting one or more operating parameters of washing machine appliance 100, as described above. After the color contamination issue is addressed at step 320 and 322, method 300 may proceed step 318 where the wash cycle proceeds until completion.

FIGS. 4 and 5 depict steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure. Moreover, although aspects of method 200 and method 300 are explained using washing machine appliance 100 as an example, it should be appreciated that this method may be applied to the operation of any suitable laundry appliance, such as another washing machine appliance.

As explained above, aspects of the present subject matter are directed to a method of color detection along with turnover evaluation using a camera and artificial intelligence in a top load washing machine. For example, a downward facing camera may be installed in the middle of the lid or underneath the water outlet of the washing machine. The top view images may be analyzed to identify the presence of an undesirable article of clothing. For example, for a given frame, a color histogram may be generated and may be used to identify a garment having an abnormal color relative to the remainder of a load of clothes.

In practice, after the washing machine is filled with load, wash cycle parameters may be entered or determined, and the wash cycle may be initiated. A turnover detection algorithm (e.g., which may or may not utilize artificial intelligences techniques) may be started, where the load turns at least once (or X times) to make a good decision using the camera. Color detection history may be recorded and the method may include checking to determine whether a minimal turn over performance is satisfied or not. If the minimal turn over performance is not satisfied, then the turnover detection algorithm may be continued or started again. If the minimal turn over performance is satisfied, then an abnormal color detection process may be implemented to evaluate the load of clothes.

If any issues are detected (e.g., dark item in light-colored load), then the user may be alerted with sample images, and responsive actions may be taken to minimize the color contamination. For example, the actions can include reducing the water temperature, adjusting the cycle time, adjusting the agitation profile or strength, adjusting the water level, etc. If no outlier garments are detected or the load is not deemed abnormal, the remaining wash cycle may be continued. Thus, this method may identify abnormal color mixes of load by using a cluster (e.g., a grouping of similar colors) after evaluating the turnover performance and may take responsive actions to minimize the contamination of a load or damage to articles of clothing. The color mix evaluation may be started after starting the cycle and may detect colored clothes hiding underneath the load of clothes in the wash tub.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A washing machine appliance, comprising:
a wash tub positioned within a cabinet;
a wash basket rotatably mounted within the wash tub and defining a wash chamber configured for receiving a load of clothes;
a motor assembly mechanically coupled to the wash basket for selectively rotating the wash basket;
a camera assembly mounted within the cabinet in view of the wash chamber; and
a controller operably coupled to the motor assembly and the camera assembly, the controller being configured to:
obtain a first image of the load of clothes using the camera assembly;
operate the motor assembly to tumble the load of clothes;
obtain a second image of the load of clothes using the camera assembly;
analyze the first image and the second image using an image recognition process to identify one or more outlier garments; and
implement a responsive action in response to identifying the one or more outlier garments.

2. The washing machine appliance of claim 1, wherein operating the motor assembly to tumble the load of clothes comprises:
operating the motor assembly to rotate the wash basket;
determining that a turnover condition of the load of clothes has been satisfied; and
stopping the motor assembly when the turnover condition is satisfied.

3. The washing machine appliance of claim 2, wherein determining that the turnover condition of the load of clothes has been satisfied comprises:
determining that the motor assembly has been operating for a predetermined amount of time.

4. The washing machine appliance of claim 2, wherein determining that the turnover condition of the load of clothes has been satisfied comprises:
analyzing the first image or the second image to determine that the load of clothes has been tumbled.

5. The washing machine appliance of claim 1, wherein at least one of the first image or the second image is obtained while the motor assembly is rotating to tumble the load of clothes.

6. The washing machine appliance of claim 1, wherein the first image and the second image are cropped to focus on a bottom center of the wash basket.

7. The washing machine appliance of claim 1, wherein analyzing the first image and the second image comprises:
generating a color histogram of the load of clothes.

8. The washing machine appliance of claim 1, wherein analyzing the first image and the second image comprises:
identifying an outlier darkness level of the one or more outlier garments and a load darkness level of a remainder of the load of clothes; and
determining that a difference between the outlier darkness level and the load darkness level exceeds a predetermined threshold.

9. The washing machine appliance of claim 1, wherein the image recognition process is a machine learning image recognition process comprising at least one of a convolution neural network (“CNN”), a region-based convolution neural network (“R-CNN”), a deep belief network (“DBN”), or a deep neural network (“DNN”) image recognition process.

10. The washing machine appliance of claim 1, further comprising:
a water supply for providing a flow of wash fluid into the wash tub, wherein implementing the responsive action comprises operating the water supply to lower a temperature of the flow of wash fluid.

11. The washing machine appliance of claim 1, further comprising:
a water supply for providing a flow of wash fluid into the wash tub, wherein implementing the responsive action comprises lowering a water level within the wash tub.

12. The washing machine appliance of claim 1, wherein implementing the responsive action comprises adjusting a cycle time of a wash cycle.

13. The washing machine appliance of claim 1, further comprising:
an agitation element for agitating the load of clothes, wherein implementing the responsive action comprises adjusting an agitation profile or strength of the agitation element.

14. The washing machine appliance of claim 1, wherein implementing the responsive action comprises:
providing a user notification that the load of clothes contains the one or more outlier garments.

15. The washing machine appliance of claim 1, further comprising:
a user interface panel, wherein the user notification is provided through the user interface panel.

16. The washing machine appliance of claim 1, wherein the controller is in operative communication with a remote device through an external network, and wherein the user notification is provided through the remote device.

17. The washing machine appliance of claim 1, wherein the controller is further configured to:
analyze the first image and the second image using an image recognition process to determine the load of clothes does not contain the one or more outlier garments; and
proceed with an operating cycle in response to determining that the load of clothes does not contain the one or more outlier garments.

18. The washing machine appliance of claim 1, wherein the washing machine appliance is a vertical axis washing machine appliance.

19. A method of operating a washing machine appliance, the washing machine appliance comprising a wash basket rotatably mounted within a wash tub and defining a wash chamber configured for receiving a load of clothes, a motor assembly for selectively rotating the wash basket, and a camera assembly mounted within the cabinet in view of the wash chamber, the method comprising:
obtaining a first image of the load of clothes using the camera assembly;
operating the motor assembly to tumble the load of clothes;
obtaining a second image of the load of clothes using the camera assembly;
analyzing the first image and the second image using an image recognition process to identify one or more outlier garments; and
implementing a responsive action in response to identifying the one or more outlier garments.

20. The method of claim 19, wherein operating the motor assembly to tumble the load of clothes comprises:
operating the motor assembly to rotate the wash basket;
determining that a turnover condition of the load of clothes has been satisfied; and
stopping the motor assembly when the turnover condition is satisfied.
